(19) United States
(12) Patent Application Publication
(10) Pub. No.: US 2003/0066994 A1
(43) Pub. Date: Apr. 10, 2003

(54) Vehicale crash impact absorption system

(76) Inventor: Randy Lewis, Johnson City, TN (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 09/971,444

(22) Filed: Oct. 5, 2001

(51) Int. Cl. A01K 3/00; E01F 15/00

(52) U.S. Cl. 256/13.1

(57) ABSTRACT

There is disclosed an improved vehicle crash impact absorption system. The impact absorption system comprises a frame having a first support arm, one end of which is pivotally attached to the frame and a second support arm, one end of which is pivotally attached to the frame independent of said first support arm. An impact having a first portion and a second portion. The first portion of the impact plate is pivotally mounted to the end of the first support arm remote from the frame and the second portion is pivotally mounted to the end of the second support arm remote from the frame, whereby the impact plate is supported for free floating movement. A plurality of shock absorbers are mounted between the frame and the impact plate.

### FIELD OF INVENTION

The present invention relates generally to crash impact absorption systems, and, more specifically, to a system for reducing the magnitude of an impact to motorized vehicles when they crash into stationary objects, such as a wall, abutments and barriers. The present invention also relates to a crash impact absorption system for a racetrack for motorized vehicles.

### BACKGROUND OF THE INVENTION

Various systems have been devised to provide a vehicle crash cushion for decelerating a vehicle that has left the highway or racetrack and is moving toward a wall, abutment or barrier. Some such crash cushion systems use resilient materials to absorb the impact, such as vehicle tires or flexible barrels. See for example, U.S. Pat. Nos. 6,010,275; 5,314,261 and 4,090,694. Other systems have used hydraulic cylinders or springs to absorb the vehicle impact. See for example, U.S. Pat. Nos. 4,662,611; 3,690,619; 3,638,913; 3,436,057; 3,385,564; 3,369,634; 2,974,934; and 1,449,518. However, as vehicle weights and speeds have increased, particularly in race track environments, and the heights of vehicles have increased, with the popularity of sport utility vehicles and minivans, the need for more sophisticated vehicle crash impact systems has increased.

### SUMMARY OF THE INVENTION

The present invention satisfies the above-described needs by providing an improved vehicle crash impact absorption system. The improved vehicle crash impact absorption system of the present invention comprises an impact plate mounted to a wall such that the impact plate is free floating. A plurality of shock absorbers are mounted between the impact plate and the wall, such that when the impact plate is impacted by a motorized vehicle, the impact plate can tilt to distribute at least a portion of the force of the impact among the plurality of shock absorbers.

In an alternate embodiment, the present invention comprises a frame having a first and second support arm pivotally attached to thereto at one end thereof. An impact plate having first and second portions is pivotally mounted to the ends of each of the first and second support arms remote from said frame such that the first and second portion are attached to the first and second support arms, respectively, whereby the impact plate is supported for free floating movement. A plurality of shock absorbers is mounted between the frame and the impact plate.

Accordingly, it is an object of the present invention to provide an improved vehicle crash impact absorption system.

Another object of the present invention is to provide a vehicle crash impact absorption system that can accommodate impacts from vehicles of various heights.

A further object of the present invention is to provide a vehicle crash impact absorption system that more evenly distributes the force of the impact of a vehicle among a plurality of shock absorbing devices.

Yet another object of the present invention is to provide a vehicle crash impact absorption system that reduces the amount of rebound resulting from a vehicle impact.

Another object of the present invention is to provide a vehicle crash impact absorption system that automatically resets itself to its normal operating position after a vehicle impact.

These and other objects, features and advantages of the present invention will become apparent after a review of the following detailed description of the disclosed embodiments and the appended drawing and claims.

### BRIEF DESCRIPTION OF THE DRAWING

FIG. 1 is perspective view of a disclosed embodiment of the support frame of the impact absorption system of the present invention.

FIG. 2 is a schematic view of a disclosed embodiment of a racetrack and the positioning of the impact plates of the impact absorption system of the present invention.

FIG. 3 is a top plan view shown in partial cutaway of the support frame shown in FIG. 1 with the impact plate attached thereto.

FIG. 4 is a partial top plan view of an alternate disclosed embodiment of the impact absorption system of the present invention, shown in partial cutaway and partial phantom.

FIG. 5 is a partial side view of the impact absorption system shown in FIG. 3 shown in partial cutaway and partial phantom.

FIG. 6 is a rear view of a disclosed embodiment of the impact plate of the impact absorption system of the present invention.

FIG. 7 is a top plan view of the impact plate shown in FIG. 6.

### DETAILED DESCRIPTION OF THE DISCLOSED EMBODIMENTS

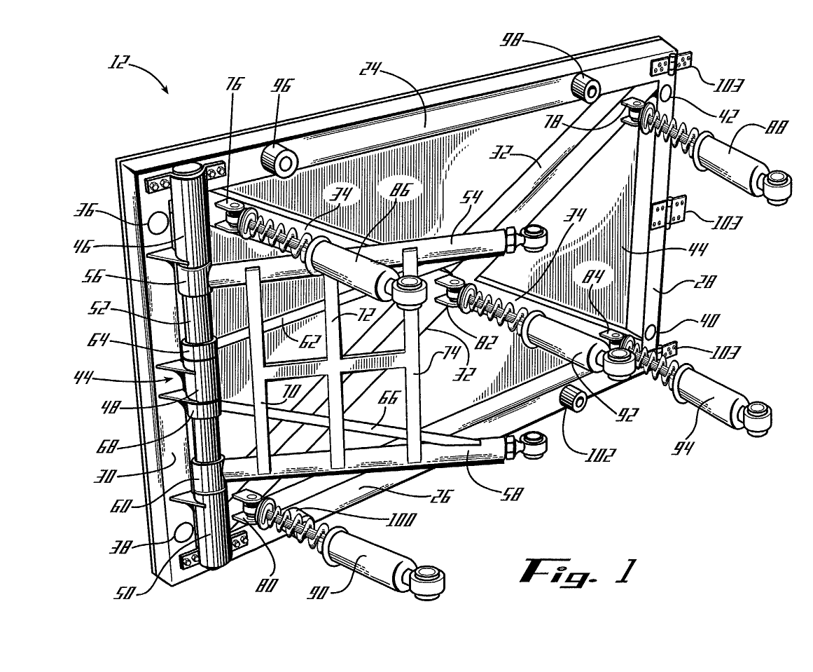

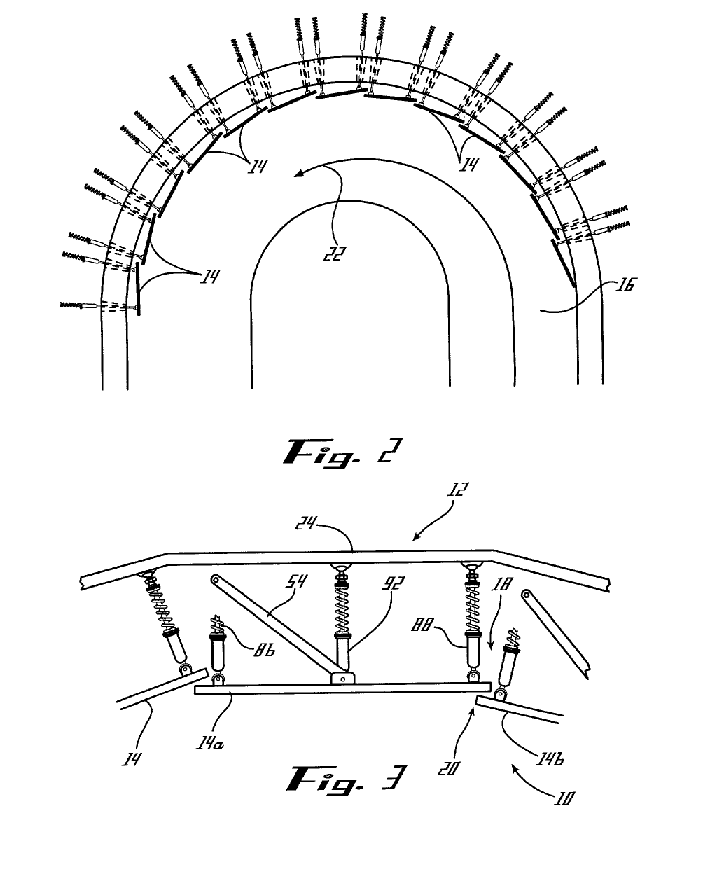

With reference to the drawing in which like numbers indicate like elements throughout the several views, it can be seen that there is a vehicle crash impact absorption system 10 (FIG. 3). The vehicle crash impact absorption system 10 is comprised of a support frame 12 (FIG. 1) and an impact plate 14 (FIG. 3). It is intended that a plurality of the impact absorption systems 10 would be positioned around the periphery of a race track 16, such as at the curve shown in FIG. 2, in an overlapping relationship with the leading edge 18 of one impact plate 14a being positioned behind the trailing edge 20 of the preceding impact plate 14b with respect to the direction of race car travel, such as shown by the arrow 22. It should be understood that vehicles on different racetracks and different vehicles on the same racetrack sometime travel if different directions; i.e., clockwise instead of counterclockwise. Therefore, it is necessary to position the support frame 12 correctly for the specific direction of travel of the vehicles. As shown in FIG. 1, the support frame 12 is oriented for vehicles traveling from left to right.

The support frame 12 comprises a pair of horizontal frame members 24, 26 and a pair of vertical frame members 28, 30 assembled into a rectangular frame (FIG. 1). Each of the frame members 24, 26, 28, 30 is made from rectangular, tubular steel. The frame members 24, 26, 28, 30 are welded together to form the rectangular frame. To provide additional strength, diagonal cross braces 32, 34 are provided. The cross braces 32, 34 are welded to the frame members 24, 26, 28, 30 and to themselves. Holes 36, 38 are provided in vertical frame member 30 and holes 40, 42 are provided in vertical frame member 28. The holes 36, 38, 40, 42 are sized and shaped to receive mounting bolts (not shown) for bolting the support frame 12 to the concrete wall 44 of the race track 16 to thereby hold the frame securely in position on the wall.

Attached at one end of the support frame 12 is a swing arm assembly 44. The swing arm assembly 44 comprises an upper sleeve 46, central sleeve 48 and lower sleeve 50. The sleeves 46, 48, 50 are attached to the frame members 24, 26, 30 by bolting and welding. The sleeves 46, 48, 50 are sized and shaped to receive a shaft 52 therein. Furthermore, the sleeves 46, 50 have closed ends so that the shaft 52 is captured between those sleeve.

An upper elongate swing arm 54 is attached, such as by welding, at one end to a bearing sleeve 56 which is pivotably disposed on the shaft 52. An lower elongate swing arm 58 is attached, such as by welding, at one end to a bearing sleeve 60 which is pivotably disposed on the shaft 52. An upper diagonal elongate brace arm 62 is attached, such as by welding, at one end to the upper swing arm 54 and at the other end to a bearing sleeve 64 pivotably disposed on the shaft 52. A lower diagonal elongate brace arm 66 is attached, such as by welding, at one end to the lower swing arm 58 and at the other end to a bearing sleeve 68 pivotably disposed on the shaft 52. Thus, the upper and lower swing arms 54, 58 are pivotably mounted on the shaft 52 and can move in an arcuate path about the shaft. Attached to the upper swing arm 54 are three cross pieces 70, 72, 74 which extend downwardly toward the lower swing arm 58, but are not attached to the lower swing arm. Thus, it will be appreciated that the lower swing arm can move inwardly toward the support frame 12 independently of the upper swing arm 54. However, if the upper swing arm 54 moves inwardly toward the support frame 12, the cross members 70, 72, 74 will contact the lower swing arm 58 and move it along with the upper swing arm.

Disposed on the cross braces 32, 34 are five shock absorber mounts 76, 78, 80, 82, 84. Pivotably attached to the shock absorber mounts 76, 78, 80, 82, 84 are double adjustable automotive shock absorbers 86, 88, 90, 92, 94. Double adjustable shock absorbers are well known to those skilled in the art and are commercially available from sources, such as HAL® shocks from QA1 Precision Products, Inc., of Stuart, Fla. By using double adjustable shock absorbers, the amount of resistance provided by the shock absorber can be varied depending on the type and weight of car that would impact the impact absorption systems 10.

Attached to the support frame 12 are four bumper pads 96, 98, 100, 102. The bumper pads 96, 98, 100, 102 provide further cushioning to the impact plate 12 if movement of the impact plate 14 is such that it touches the bumper pads. Hinges 103 are provided on the vertical frame member 28 for interconnecting adjacent support frames 12. Matching bolt holes (not shown) are formed in the sleeves 46, 48, 50 of the adjacent support frame for attachment of the hinges 103 thereto.

The impact plate 14 is a steel plate approximately one-half inch thick. The impact plate 14 is reinforced by a horizontal steel I-beam 104, a vertical steel I-beam 106 and two diagonal steel I-beams 108, 110. The I-beams 104, 106, 108, 110 are attached to the steel impact plate 14, such as by welding. Additionally, there are five brackets 112, 114, 116, 118, 120 for pivotably attaching the ends of the five shock absorbers 86, 88, 90, 92, 94 remote from the ends attached to the shaft 52. Furthermore, there are two brackets 122, 124 for pivotably attaching the ends of the swing arms 54, 58 remote from the shaft 52.

As an additional feature, the impact plate 14 is covered with a layer of Kevlar®, a product of Dupont De Nemours. The Kevlar® fabric is adhered to the impact plate with an epoxy adhesive. The Kevlar® fabric layer provides extra strength to the impact plate 14 and also provides shape memory.

It will be appreciated by those skilled in the art that the impact plate 14 is mounted to the support frame 12 in a free-floating relationship. By free floating is meant that the impact plate 14 has the freedom to move toward and away from the support frame 12, and the impact plate can also move laterally with respect to the support frame. It will further be appreciated that the impact plate 14 can tilt toward or away from the support frame 12. For example, the bottom of the impact plate 14 can move toward the support frame more than the top of the frame member or the top and bottom of the impact plate can move toward the support frame the same amount. The term free-floating is intended to describe all these features.

It is further specifically contemplated that in an alternate embodiment, the sleeves 46, 48, 50 and the shock absorbers 86, 88, 90, 92, 94 may be mounted directly to a concrete wall, thereby eliminating the frame members 24, 26, 28, 30. In such an embodiment, the swing arms 54, 58 and the shock absorbers 86, 88, 90, 92, 94 would work in the identical manner as described above. Thus, the only difference is the elimination of the support frame 12.

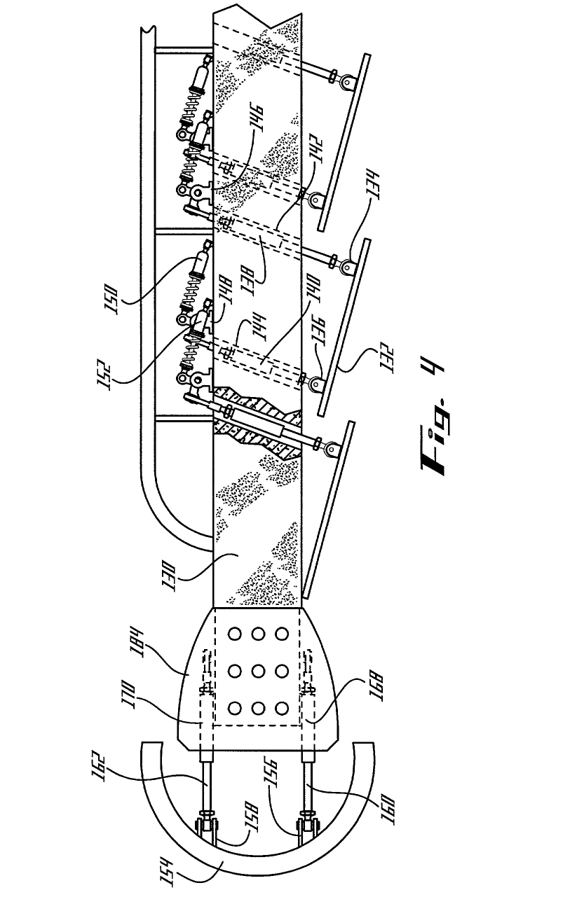

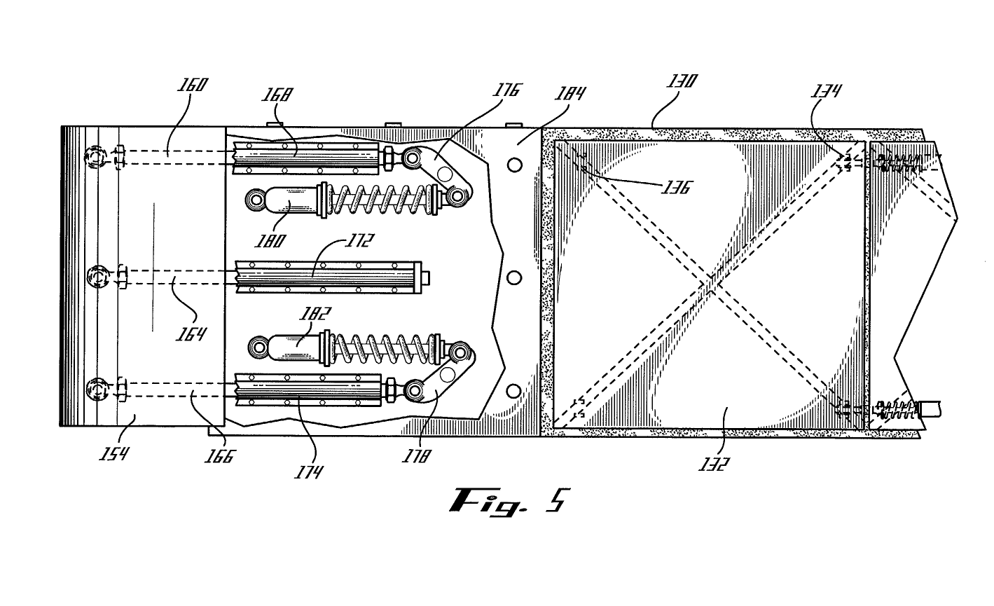

With reference to FIGS. 4 and 5, it will be seen that there is disclosed an alternate embodiment of the crash impact absorption system of the present invention. FIGS. 4 and 5 show a conventional concrete dividing wall 130, such as would be present between a racetrack and a pit area. For this particular embodiment of the present invention, there are two types of crashes that are to be protected against: a crash into the side of the wall 130 and a crash into the end of the wall or abutment. Two different mechanisms are disclosed to protect both types of crashes. For the sidewall crash, there is provided an impact plate 132 of the same construction as the impact plate 14 described above. The impact plate 132 is reinforced with steel I-beams in the same manner as the impact plate 14 described above. On the backside of the impact plate 132 are four mounting brackets 134, 136 (only two of which are shown in FIG. 4). Attached to each mounting bracket 134, 136 is a push rod 138, 140, respectively. The push rods 138, 140 extend through holes 142, 144, respectively, formed in the concrete wall 130, such as by drilling. Bell cranks 146, 148 are attached to the opposite side of the wall 130 that includes the impact plate 132. The ends of the push rods 138, 140 not connected to the brackets 136, 138 are connected to one arm of the bell cranks 146, 148, respectively. The other arm of the bell cranks 146, 148 is attached to one end of double adjustable shock absorbers 150, 152, respectively. The opposite end of the shock absorbers 150, 152 are secured to the concrete wall 130, such as by a bolt (not shown) anchored in the wall. It should be understood that push rods, bell cranks and shock absorber mechanisms are positioned at each of the four corners of the impact plate 132 although only two such mechanisms are visible in FIG. 4.

A plurality of these impact plates and associated mechanisms are placed along the length of the wall 130 in overlapping arrangement, as shown in FIG. 4. The leading edge of the first impact plate shown in FIG. 4; i.e., the impact plate illustrated with only one shock absorber, is attached to the concrete wall 130 by means of a hinge bolted to the wall. Due to its relatively compact design, the crash impact absorption system shown in FIG. 4 is particularly well suited for use on racetracks that have limited space.

The mechanism to protect against crash impacts into the wall abutment includes a curved impact plate 154. The impact plate 154 includes mounting brackets 156, 158 to which are attached upper push rods 160, 162, respectively. Intermediate push rod 164 and lower push rod 166 are provided on both sides of the wall 130. The push rods 160, 162, 164, 166 extend through guide sleeves 168, 170, 172, 174, respectively attached to the wall 130. Bell cranks 176, 178 are mounted on the wall 130. As best shown in FIG. 5, the ends of the upper push rod 160 and lower push rod 166 remote from the impact plate 154 are attached to one arm of the bell cranks 176, 178, respectively. The other arm of the bell cranks 176, 178 are attached to one end of the double adjustable shock absorbers 180, 182, respectively. The other ends of the shock absorbers 180, 182 are secured to the concrete wall 130, such as by a bolt (not shown) anchored in the wall. A protective shroud 184 is provided to protect the moving parts of this mechanism. It should be understood that the opposite side of the wall 132 shown in FIG. 5 would appear as a mirror image of that shown in FIG. 5, except for the absence of the impact plates 132. Thus, there are two shock absorbers operatively associated with the four corners of the impact plate 154; i.e., two shock absorbers provided on each side of the wall 132.

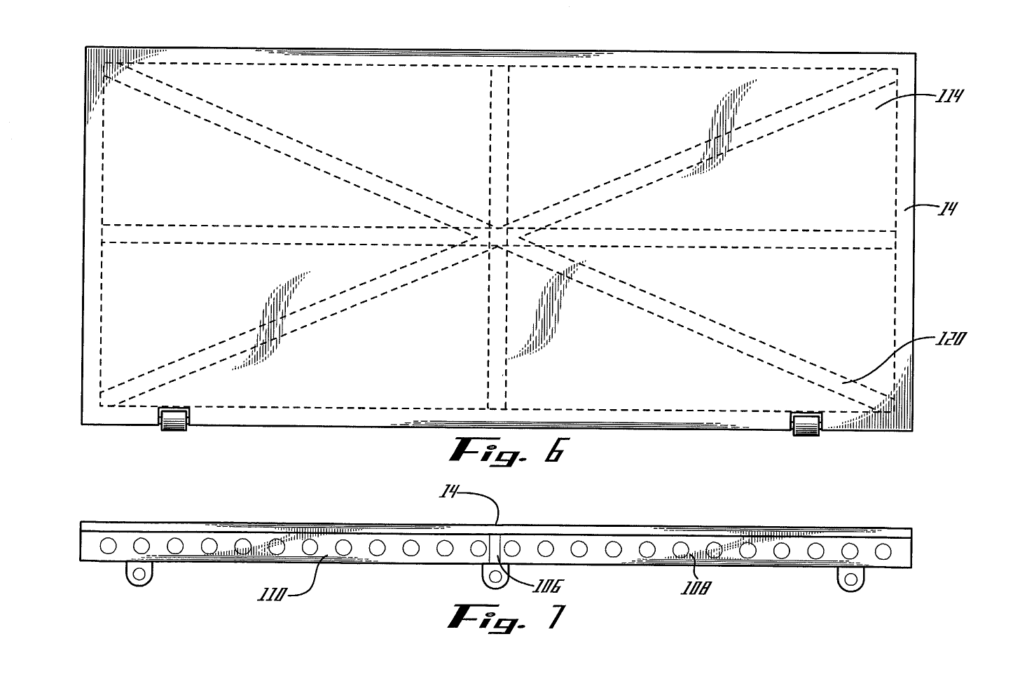

Operation of the impact absorption systems of the present invention will now be considered. With reference to FIGS. 1-3, 6 and 7, when a car impacts the impact plate 14, the impact plate moves toward the frame 12. The movement of the impact plate 14 causes compression of the spring component of the shock absorbers 86, 88, 90, 92, 94, thereby providing a resistive force. Thus, as the springs of the shock absorbers 86, 88, 90, 92, 94 are compressed, a portion of the energy of the crash is transferred to the springs. An advantage of using shock absorbers in the present invention is that after the energy of the crash has been transferred to the springs of the shock absorber, and since the shock absorbers are hydraulically damped, the springs will not rebound with a force equal to that of the impact and otherwise push the crashed car back out into the race track. Instead, the springs of the shock absorbers 86, 88, 90, 92, 94 will rebound relatively slowly and will trend to return to their original uncompressed state.

Another advantage of the present invention is that if the impact of a car on the impact plate 14 occurs relatively low on the impact plate, the impact plate can tilt thereby compressing the lower shock absorbers 90, 94 more than the upper shock absorbers 86, 88. The tilting of the impact plate 14 helps deflect debris downwardly, thereby reducing the possibility of debris flying into a spectator crowd at a race and causing injury. Furthermore, the tilting of the impact plate 14 helps more evenly distribute the force over the entire surface of the impact plate and thereby transmit it to the shock absorbers 86, 88, 90, 92, 94. Furthermore, since the resistance of the shock absorbers 86, 88, 90, 92, 94 is adjustable, they can be adjusted to accommodate different impact forces resulting from cars of different weights and/or different speeds.

With reference to FIG. 4, when a car impacts the impact plate 132, the impact plate moves inwardly toward the wall 130. The movement of the impact plate 14 toward the wall 130 causes the push rods 138, 140 to move through the holes 142, 144 in the wall. The movement of the push rods 138, 140 causes arms of the bell cranks 150, 152 to pivot about their axis. That is, the arm of the bell crank 150, 152 connected to the push rod 138, 140 rotates clockwise, thus causing the other arm of the bell crank to compress the spring of the associated shock absorber 150, 152, respectively.

With respect to FIG. 5, if a car impacts the impact plate 154, the impact plate will move inwardly toward the wall 130. The movement of the impact plate 154 toward the wall causes the push rods 160, 162, 164, 166 to also move toward the wall 130. The movement of the push rods 160, 162, 166 toward the wall 130 causes the associated bell cranks to rotate clockwise thereby compressing the springs of the associated shock absorbers 180, 182.

While the foregoing disclosed embodiment has been described in terms of use in connection with a vehicle race track, it is specifically contemplated that the present invention can also be used in connection with conventional highway systems, lane dividers, bridge abutments, guard rails, and the like.

It should be understood, of course, that the foregoing relates only to certain disclosed embodiments of the present invention and that numerous modifications or alterations may be made therein without departing from the spirit and scope of the invention as set forth in the appended claims.

What is claimed is:

1. An apparatus comprising:
a frame;
a first support arm, one end of said first support arm being pivotally attached to said frame;
a second support arm, one end of said second support arm being pivotally attached to said frame;
an impact plate, said impact plate having a first portion and a second portion, said first portion being pivotally mounted to the end of each of said first support arm remote from said frame and said second portion being pivotally mounted to said end of said second support arm remote from said frame, whereby said impact plate is supported for free floating movement; and
a plurality of shock absorbers mounted between said frame and said plate.

2. The apparatus of claim 1, wherein said impact plate is rectangular and said shock absorbers are disposed adjacent each corner of said impact plate.

3. The apparatus of claim 1, wherein said impact plate includes reinforcing members to reduce the amount of impact plate deformation resulting from an impact.

4. The apparatus of claim 1, wherein said impact plate includes an exterior layer of Kevlar.

5. The apparatus of claim 1, wherein said frame is sized and shaped for attachment to a concrete wall of a racetrack for motorized vehicles.

6. An apparatus for use in combination with a concrete racetrack wall, said apparatus comprising:
an impact plate mounted to said wall such that said impact plate is free floating; and
a plurality of shock absorbers mounted between said impact plate and said wall, such that when said impact plate is impacted by a motorized vehicle, said impact plate can tilt to distribute at least a portion of the force of said impact among said shock absorbers.

7. The apparatus of claim 6, wherein said impact plate is rectangular and said shock absorbers are disposed adjacent each comer of said impact plate.

8. The apparatus of claim 6, wherein said impact plate includes reinforcing members to reduce the amount of impact plate deformation resulting from an impact.

9. The apparatus of claim 6, wherein said impact plate includes an exterior layer of Kevlar.

10. The apparatus of claim 6, wherein said frame is sized and shaped for attachment to a concrete wall of a racetrack for motorized vehicles.

11. An apparatus for use in conjunction with a wall, said wall having a first side and a second side, said apparatus comprising:
an impact plate disposed on said first side of said wall;
a bell crank mounted on said second side of said wall;
at least one arm pivotably attached at one end to said impact plate, said arm extending from said impact plate through a hole defined by said wall to said second side of said wall, the other end of said arm being pivotably attached to said bell crank;
a shock absorber attached at one end to said second side of said wall, the other end of said shock absorber being pivotably attached to said bell crank, such that movement of said impact plate toward or away from said wall is transferred through said arm and bell crank to said shock absorber.

12. The apparatus of claim 11, wherein said impact plate comprises a steel plate reinforced with I-Beams on the side of said steel plate adjacent said wall.

13. The apparatus of claim 12 further comprising a layer of Kevlar attached to said steel plate on the side opposite said I-beams.

14. The apparatus of claim 13, wherein said layer of Kevlar is attached to said steel plate with an epoxy adhesive.

15. An apparatus for use in conjunction with a wall abutment, said wall abutment having an end, a first side and a second side, said apparatus comprising:
a curved impact plate disposed adjacent said end of said wall abutment, said curved impact plate extending from said first side of said wall abutment to said second side of said wall abutment;
a first bell crank attached to said first side of said wall;
at least one actuator arm attached at one end to said impact plate, the other end of said actuator arm being pivotably attached to said first bell crank; and
at least one shock absorber pivotably attached at one end to said first bell crank, the other end of said shock absorber being attached to said first side of said wall.

16. The apparatus of claim 15 further comprising:
a second bell crank attached to said second side of said wall;
at least one actuator arm attached at one end to said impact plate, the other end of said actuator arm being pivotably attached to said second bell crank; and
at least one shock absorber pivotably attached at one end to said second bell crank, the other end of said shock absorber being attached to said first side of said wall.

17. An apparatus comprising:
a first support arm, one end of said first support arm being pivotally attached to a substrate;
a second support arm, one end of said second support arm being pivotally attached to said substrate;
an impact plate, said impact plate having a first portion and a second portion, said first portion being pivotally mounted to the end of each of said first support arm remote from said frame and said second portion being pivotally mounted to said end of said second support arm remote from said frame, whereby said impact plate is supported for free floating movement; and
a plurality of shock absorbers mounted between said substrate and said plate.
